(19) United States
(12) Patent Application Publication
(10) Pub. No.: US 2024/0311767 A1
(43) Pub. Date: Sep. 19, 2024

(54) AUTOMATIC JOB ARCHITECTURE GENERATION SYSTEM

(71) Applicant: GLOAT LTD, Tel Aviv (IL)

(72) Inventor: Amichai SCHREIBER, Tel Aviv (IL)

(21) Appl. No.: 18/122,144

(22) Filed: Mar. 16, 2023

(51) Int. Cl. G06Q 10/1053; G06Q 10/0631

(52) U.S. Cl. CPC G06Q 10/1053; G06Q 10/063112

(57) ABSTRACT

A method of forming a job architecture of an organization, including collecting information from employees of the organization by an application executed on a computer, analyzing the information with a neural network to form a job hierarchy for the organization, associating each employee of the organization with a job of the job hierarchy to form an job architecture for the organization, and displaying the job architecture on a display.

### FIELD OF THE INVENTION

The present disclosure relates generally to a system and method for generating a job architecture for an organization and taking actions based on the job architecture.

### BACKGROUND OF THE INVENTION

In many organizations employees are hired over time, based on a need to have a skilled person to perform required tasks. Over time the organization may have many employees without having an architecture defining what jobs are required, what tasks each job handles and what skills are required for each job. Eventually the organization may find that the lack of an up to date job architecture makes it difficult to plan ahead, for example regarding training existing employees, adding new employees and removing redundant employees. In some cases one department may be hiring while another department is firing employees with the same qualifications.

It is thus desirable to automatically form a mapping of the jobs and employees of the organization, covering what jobs/roles are required, what tasks are covered by each job, what skill/education is required for each job, what experience level is required for each job (e.g. senior/junior) and what are the qualifications of the people fulfilling the available jobs/positions.

The system can then be used to determine if there is a lack of qualified employees for certain tasks. If certain employees need additional training, if certain employees are redundant, if certain employees can handle other tasks instead of adding new employees and other applications.

### SUMMARY OF THE INVENTION

An aspect of an embodiment of the invention, relates to a system and method for forming a job architecture of an organization. Initially the system collects information, including information from employees related to their jobs, for example job title, CV, education and other information. Optionally the employer may add information regarding jobs/positions that are currently not filled.

A computerized application collects the information and analyzes it with a neural network that is trained to form a job hierarchy for the organization. The neural network is configured to determine a hierarchy of the jobs and skills required for each job. The system then associates each employee of the organization to a job of the hierarchy to form a job architecture. The job architecture provides a map of all the jobs required by the organization and displays the job architecture on a display for the review of the employer. Optionally, the application identifies jobs that are not filled and jobs that deal with overlapping responsibilities.

There is thus provided according to an embodiment of the disclosure, a method of forming a job architecture of an organization, comprising:
Collecting information from employees of the organization by an application executed on a computer;
Analyzing the information with a neural network to form a job hierarchy for the organization;
Associating each employee of the organization with a job from the job hierarchy to form a job architecture for the organization;
Displaying the job architecture on a display.

In an embodiment of the disclosure, the application is configured to identify missing or redundant employees from the job architecture. Optionally, the application is configured to enable an employer to add information regarding jobs that are not currently filled by employees. In an embodiment of the disclosure, the application suggests training for employees to improve their qualification relative to colleagues. Optionally, the neural network trains a job similarity model to identify similar jobs based on job titles. In an embodiment of the disclosure, the neural network trains a skill embedding space model to identify skills related to job titles. Optionally, the neural network trains a model to correlate between titles and skills. In an embodiment of the disclosure, the neural network trains a job similarity model to cluster and group jobs. Optionally, the neural network is trained based on a job description data set that describes skills required for specific job titles. In an embodiment of the disclosure, neural network is trained based on an employee job description data set that includes a series of career transitions of employees.

There is further provided according to an embodiment of the disclosure, a computer for producing a job architecture of an organization, comprising

A processor and memory programmed to execute an application performing:
Collecting information from employees of the organization;
Analyzing the information with a neural network to form a job hierarchy for the organization;
Associating each employee of the organization with a job of the job hierarchy to form an job architecture for the organization;
Displaying the job architecture on a display.

There is further provided according to an embodiment of the disclosure, a non-transitory computer readable medium comprising a set of instructions that are executable by a computer to perform the method described above.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1A is a schematic illustration of a system for creating and handling a job architecture in an organization, according to an embodiment of the disclosure;

FIG. 1B is a schematic illustration of a job architecture in an organization, according to an embodiment of the disclosure;

FIG. 2 is a schematic illustration of a flow diagram of a method of creating a job architecture, according to an embodiment of the disclosure;

FIG. 3 is a schematic flow diagram of a method of analyzing information to build a job hierarchy, according to an embodiment of the disclosure;

FIGS. 4A and 4B are schematic illustrations of a job hierarchy in different types of companies, according to an embodiment of the disclosure;

FIG. 5 is a schematic block diagram of the creation and use of a system including neural networks for preparing a job architecture, according to an embodiment of the disclosure;

FIG. 6A is a schematic illustration of an architecture of a model that generates a skill embedding space, according to an embodiment of the disclosure;

FIG. 6B is a schematic illustration of a skill embedding space, according to an embodiment of the disclosure; and

FIG. 7 is a schematic illustration of a similarity model to identify job similarities based on career paths, according to an embodiment of the disclosure.

### DETAILED DESCRIPTION

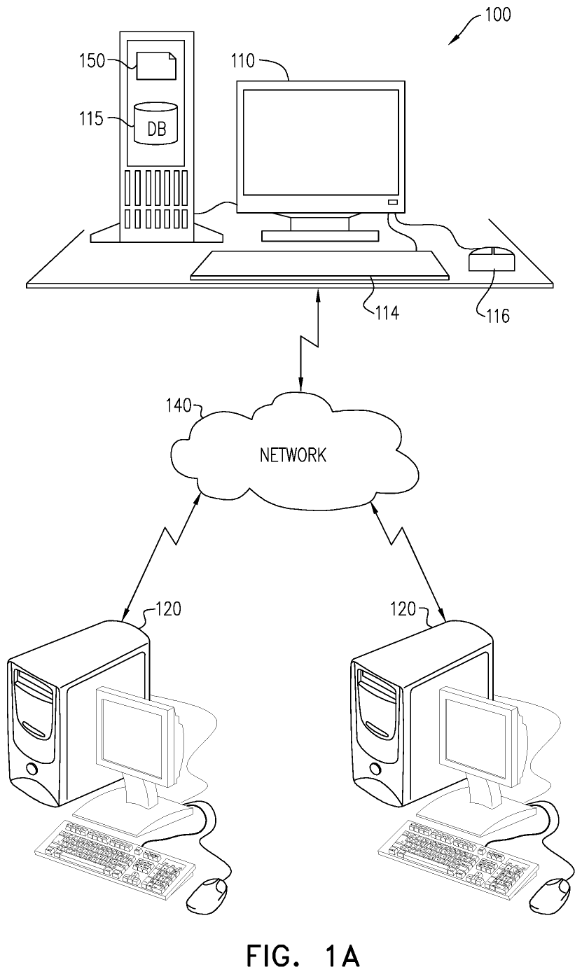

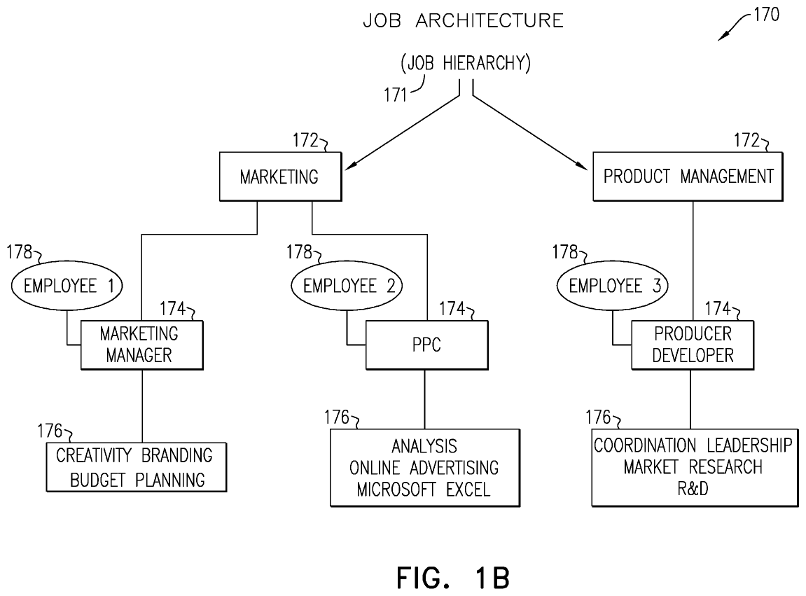

FIG. 1 is a schematic illustration of a system 100 for creating and handling a job architecture in an organization and FIG. 1B is a schematic illustration of a job architecture 170, according to an embodiment of the disclosure. System 100 includes a computerized server 110 with a processor and memory that executes an application 150 for accepting and analyzing employee information to form a job architecture 170 for an organization. The job architecture 170 is made up from the combination of two sets of data: the jobs in the organization and information of the employees fulfilling the jobs.

In an embodiment of the disclosure, the resulting job architecture 170 includes:
1. a hierarchy of jobs 171 comprising a collection of job families 172 (represented by generic job titles 174); under each job family 172 the job architecture 170 provides a collection of more specific job profiles belonging to the job family 172 (represented by more specific job titles 174);
2. a descriptive group of skills 176 or activities that are at the core of each job;
3. a mapping of each existing employee 178 to one of the job profiles (represented by the job titles 174).

In an embodiment of the disclosure, the job architecture 170 is created by collecting information from the employees of the organization. Each individual contributes to forming a big picture that is formed by the system 100. Optionally, employee information can be entered at the server 110, for example in a small organization each employee enters information directly at the server 110 using local input devices (e.g. a keyboard 114 and mouse 116) and local output devices (e.g. a display 112). Alternatively, computerized workstations 120 may be connected over a network 140 (e.g. over a corporate LAN or WAN such as an intranet or the Internet) and configured to access application 150 to input their information. Optionally, the server may be implemented as a cloud service. In some embodiments of the disclosure, the job architecture 170 is exported to remote systems, for example human capital management systems.

In an embodiment of the disclosure, application 150 may provide each employee with forms (e.g. electronic forms) to enter their information or accept documents (e.g. a job history/course of life document (curriculum vitae-CV)). Optionally, the information is stored in a database 115 at server 110 or at a dedicated storage service, for processing. In an embodiment of the disclosure, the collected information from the employees may include:
1. The employee's job title;
2. The employee's CV;
3. The employee's education/degrees;
4. The employee's skills (self-proclaimed, assessed by manager or assessed by another system or process);
5. A satisfaction survey;
6. Tasks that the employee deals with regularly and skills required to perform the tasks;
7. Previous jobs.

In an embodiment of the disclosure, the organization may have an organization website that includes job descriptions on a recruitment page and may also include a job description for each employee on a team page describing each employee's job history. Optionally, the organization website may serve as a source for information relating to the organization jobs and employee skills.

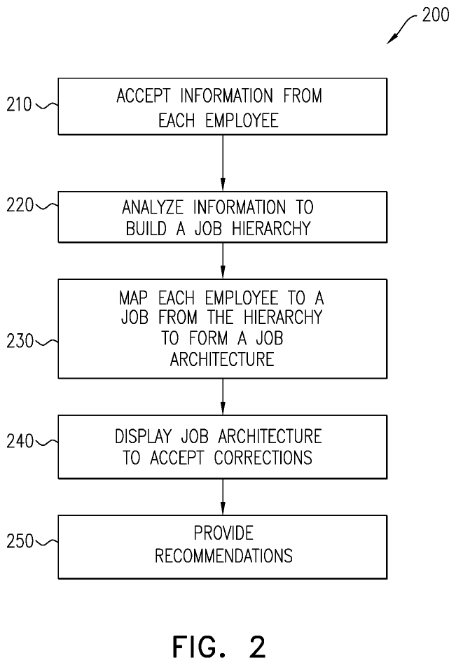

FIG. 2 is a schematic illustration of a flow diagram of a method 200 of creating a job architecture 170, according to an embodiment of the disclosure. In an embodiment of the disclosure, server 110 accepts (210) information from each employee as explained above. Optionally, the employer or administrator may add information regarding jobs that are not currently filled. For example entering job titles 174 and tasks for jobs that the employer is currently looking for employees.

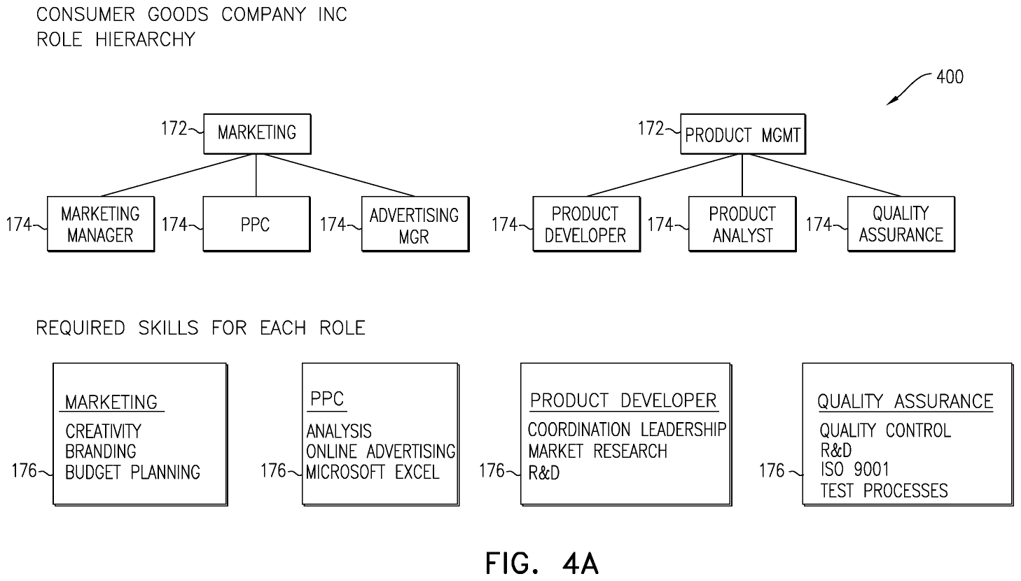

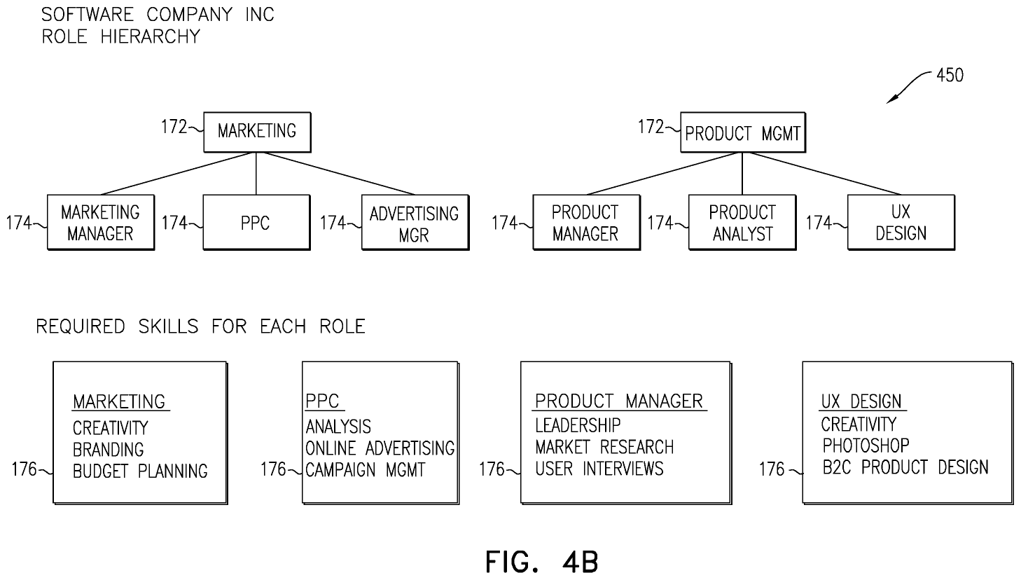

Application 150 then analyzes (220) the information to build a job hierarchy 171 for the organization. FIGS. 4A and 4B are schematic illustrations of job hierarchies 400/450 in different types of companies, according to an embodiment of the disclosure. FIG. 4A provides an example of a job hierarchy 400 in a consumer goods company and FIG. 4B provides an example of a job hierarchy 450 in a software company (note: the term “job”, “role” and “position” may be used interchangeably). Optionally, different types of companies may have jobs with similar job titles 174 but with different skills 176 associated with the job titles 174.

Using the job hierarchy 171/400/450, application 150 maps (230) each employee of the organization with a job from the hierarchy to form an organization specific job architecture 170. The application 150 may then display (240) the job architecture 170 for the employer, for example on display 112, to allow the employer to suggest improvements or corrections.

In some embodiments of the disclosure, application 150 may provide (250) recommendations for the employer, for example:
1. Suggesting job titles 174 for employees, which may better meet their qualifications, for example changing the job titles 174 of employees to job titles 174 that reflect their work more accurately.
2. Suggest removing redundant job profiles transferring employee listings from one job profile (represented by a job title 174) to another. Thus eliminating redundant job profiles if all the employees listed in them can be listed under other, better fitting profiles.
3. Suggest training to improve the qualifications of employees, so that they match the required skills for their jobs as reflected by their colleagues' profiles and/or in counterparts from other organizations.
4. Identify required jobs that are not manned with an employee or identify redundant jobs that perform the same tasks. Optionally, the organization can use the information to add or remove employees to enhance productivity of the organization.

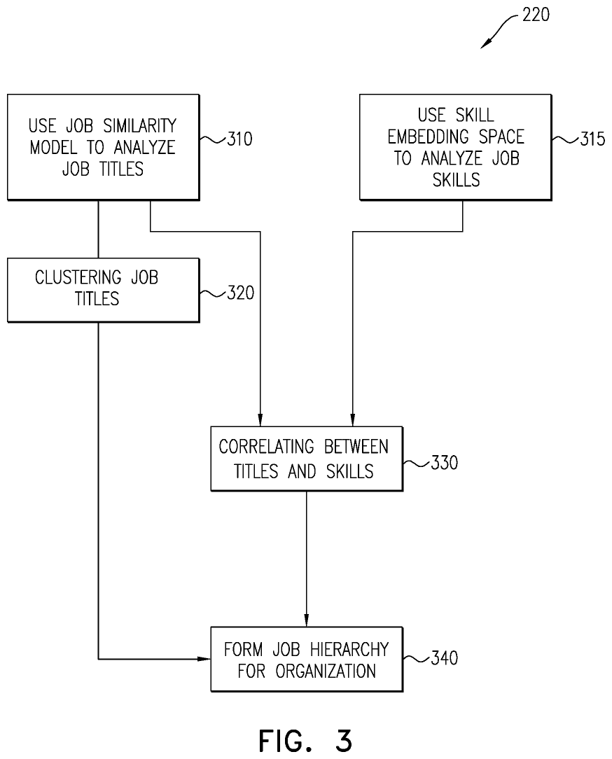

FIG. 3 is a schematic flow diagram of a method of analyzing information (220) to build a job hierarchy 171, according to an embodiment of the disclosure. In an embodiment of the disclosure, analysis of the information (220) is performed by using a trained neural network having a job similarity model to analyze job titles (310) and a skill embedding space to analyze job skills (315). The neural network uses trained statistical models to perform the analysis since the analyzed information originates from many different people without having an agreed upon terminology or format. Optionally, the job similarity model and skill embedding space weigh the different factors to determine similarity on a reliable objective scale.

In an embodiment of the disclosure, training the neural networks is performed by collecting job data to form a training model. The data may include collections of resumes from human resource (HR) agencies, professional social networks, recruitment websites and/or definitions from dictionaries and encyclopedias (e.g. Wikipedia). The neural networks are trained to handle the job information provided by the employees, wherein the job information does not follow any predefined conventions for job titles 174 and skills 176. In many cases job skills 176 can be represented by various different synonymous words. The training uses the interaction between job titles 174 and job skills 176, with one providing an indication as to the context of the use of the other.

The system is designed to overcome some key difficulties in creating a job architecture automatically, such as:
1. Job titles 174 vary. For example, the job descriptions (for similar jobs might be) “Software Engineer in ABC department” and “Senior Software Engineer”, while different employees in those jobs might call themselves “Sr. Software Developer” or “SW Dev Lead”. These are all almost synonymous, but the words and terms are different, in a way that any naive way of counting titles would fail.
2. Job titles 174 by themselves are sometimes ambiguous. In a given organization, two people might have the title “Analyst” but one of them would be managing projects while the other would be using statistical software; or two people might have the title “Engineer” but one of them would be a process engineer and the other an IT engineer. So the title does not always contain the full information to understand the person's occupation.
3. Job skills 176 vary.
   a. Different people might choose to describe themselves more verbosely or more briefly, resulting in longer or shorter lists of skills.
   b. More crucially, some people would mention generic skills (such as “software development”) while others in the same job would list more specific skills (such as “SQL drivers”), even though both of them (in this example) are proficient in software development.
   c. Each skill can be written in different ways (in a similar way as described for job titles 174) and even in different languages.
4. The question of “which skills are relevant to each job” is not trivial, even once the numbers are in place. Some of the skills are popular in all jobs and are not specific to any professionality. Other skills are pretty rare but are very typical within a specific job. So the identification of typical skills for a job needs to take into account not just the absolute number of occurrences of each skill, but also comparison between the different profiles.
5. Hierarchy is difficult to capture. There is no clear-cut rule to decide whether job profile A is “part of” job family F (or, put another way, if job profiles A and B should be part of the same family).

For these reasons, the seemingly-simple question of “what skills are required for a Software Developer” is difficult to answer: the definition of “who's a software developer” is not definite; there is a multitude of different (very specific) skills listed under such jobs; and not everyone who does possess a certain skill actually declare that skill (but sometimes others).

Having outlined some of the difficulties in automatically creating a job architecture (job title variability, job title ambiguity, variations in skill descriptions, relevancy, hierarchy), we will now show how parts of the invention address these difficulties. These descriptions are high-level and demonstrate ideas; detailed descriptions will follow.

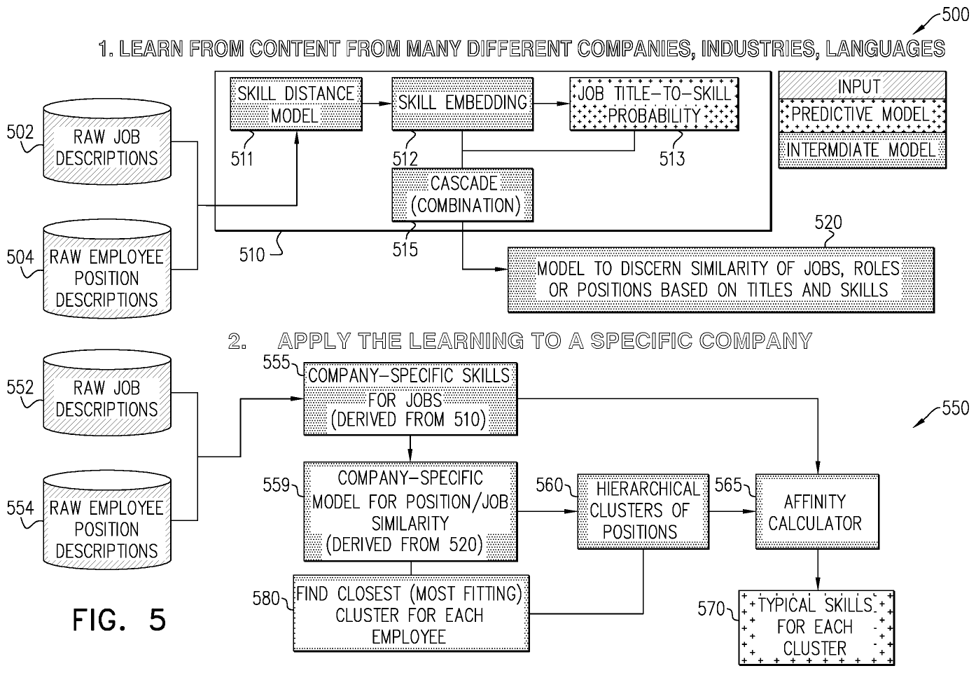

In order for system 100 to solve the problem of job title variability as well as job title ambiguity for information collected from the employees of an organization, the system uses the title embedding model 513 (FIG. 5), which embeds titles in the context of skills, and therefore treats titles as similar to the extent that they include similar skills.

In order to solve the problem of skill variability, the system uses a skill embedding space model 512 (FIG. 5, 6B). The skill embedding space model 512 refers to the skills as a pseudo-infinite collection of points in a continuous mathematical space, rather than as a finite number of discrete entities. This allows reaching a representation of both a single skill and an entire job or entire employee, which captures each one's meaning in the world of skills, without committing to a single representation and without differentiating too much between two people who are professionally similar but use different terminology and conventions. Additionally, this enables the treatment of the skills as continuous entities, and allows the model to understand which jobs are likely to include which skill. The assignment of skills and jobs to this continuous space smooths out the variability and inherent noise of different jobs (and their skills) being phrased differently, because the embedding jobs of these jobs are less susceptible to differences in phrasing.

In order to provide a hierarchy of jobs 171, we use the job-similarity model (520) as a basis for the clustering and grouping (320) the jobs in the organization. After analyzing the job titles (310) and analyzing the job skills (315) the neural network correlates (330) between job titles 174 and skills 176 for the jobs. Then by combining the results of the clustering (320) and the correlating (330) the neural network forms (340) a job hierarchy 171 for the organization.

In order to pick the skills relevant to each cluster, we devised an algorithm (affinity calculator) 565, with which—rather than simply ask “which skills are most popular in this job”—it is possible to ask “which skills are most strongly implied by a person's being in this job”. This allows bypassing the run-of-the-mill, indistinctive skills and focus on the most indicative professional skills. For example, a skill that repeats itself in many jobs might be “popular” in one job, but that doesn't make it relevant to that job, because it is not unique to it. The method described in algorithm 565 therefore focuses on a combination of:
(a) Frequency of occurrences of a skill in a job;
(b) Frequency of occurrence of a “group” of skills in one job (even though the group is not defined by anyone);
(c) The distinctive relation of the group of skills to that job, compared to other jobs.

### Detailed Description of Training and Using a System of Neural Networks:

FIG. 5 is a schematic block diagram of the creation and use of the different components for preparing a job architecture, according to an embodiment of the disclosure. The diagram illustrates two stages: a first stage 500 including training the neural networks (e.g. 511, 512, 515) by learning from content from many different companies, industries and languages and a second stage 550 including neural networks (e.g. 555, 559) for applying the learning to a specific company/organization. (The terms “job”, “role” and “position” may be used interchangeably).

Briefly, the process consists of training a model that correlates jobs with skills (510); a model that understands similarities between jobs (520); equivalent models (555 and 559 respectively) that are “better” (fine-tuned to the company); a model to create a job hierarchy 560 (based on 555 and 559); and a model to generate skills for each job in that hierarchy (565 and 570, which are based on 555 and 559).

Initially training of model 510 requires generating two data sets: a raw job description 502 data set and a raw employee job description 504 data set. The raw employee job description data set 504 may include a series of career transitions—many sequences of jobs, each job including titles and skills. Optionally, such sequences can be generated based on employee resumes in the following manner: From each job, take the job title; and from the job description 502, extract terms from a dictionary of skills (i.e. if the description contains the word “Java”, consider it as containing the skill Java).

Since job titles and skills are both sparse and subject to variability in representation, we cannot rely on any simple metric to tie two jobs or two skills together. For example, taking the titles “Software Engineer”, “SW Developer” and “Process Engineer”—the first two are very similar, and the third is not, even though from comparing the words alone, a different conclusion could be reached. Similarly, an analyst with the skill “Copyright law” and another with the skill “litigation” can both be assumed to have the skill “legal knowledge” even if not explicitly stated, so despite having different skills (on the surface), a deeper inspection is needed to understand that they are quite similar.

Because of that, and based on the inputs 502 and 504, model 510 is trained to identify the hidden relations between jobs and skills.

Following are the details of the process outlined in the previous para-graphs, and as described in FIG. 5:
a) A job-to-skills inference model 510 to predict the probability of having an additional skill in a given job/position (given its title and a list of known skills). This model includes a skill distance model 511, a skill embedding space model 512, a “job title to skill probability” model 513, and a cascade model 515 which combines the data pieces (viz., title and skills) for each job to optimize the predictions for the combinations. The job-to-skills inference model 510 attempts to overcome the problem of correlating skills to jobs for specific jobs based on the examples in the datasets. Model 510 completes the skill profile of a job/position, based on their title and explicitly-listed skills. This model needs to take into account information from the job title (e.g. “all software developers know Programming”), from the skills (e.g. “if a person (who isn't a programmer) knows SQL then they know Programming”), and also for combinations (“a software developer with the AI skill probably has the skill Python”). This is important as a first step for normalizing all available employee and job profiles, by completing missing information; as well as providing the basis for a mathematical representation that will allow comparing jobs to each other. Model 510 is based on data sets 502, 504 comprising employee job-titles (502) and employee skills (504).
b) Optionally, model 511 receives as input: (1) a bag of terms (skills) A, B and C, belonging to a single employee, and (2) additional skill D; and its output is a probability score determining if skill D is also a skill of the same person, vs being a randomly chosen skill.
c) A similarity model 520 to identify job similarities based on typical skills. The job similarity model 520 is derived from model 510, by using the weights of the layers in model 510 up to the final job embedding layer, arriving at a job embedding which places jobs close together in the embedding space if they share typical skills (e.g. “taxi driver” and “truck driver”), and far apart if they contain different typical skills (e.g., “taxi driver” and “tax accountant”).
d) a company-specific model 555 that captures relations between skills and jobs—This is a fine-tuning of 510 derived from skill distance model 511 and skill embedding space model 512 (FIG. 5), for example a retraining of skill model 510, but instead of training on all available data, it is trained on the specific organization's data), in which the probabilities of appearance of skills is tuned to fit the distribution inside the organization, which might differ significantly from the global distribution. So for example, if the model learned that “Lawyer” implies “litigation”, a law office dealing in commercial law will change this prediction to be “skills related to commercial law” rather than “litigation”.
e) a company specific model 559 for job similarity-building on 555 to generate a combined picture of job similarities, that takes into account the skill and title distribution within the target organization. Similarly to model 520, model 559 uses the job embeddings as defined by model 555 to compute similarities between jobs.
f) Based on the company specific model 559, a hierarchical clustering model 560 of jobs, grouping together jobs that are very similar. For example the hierarchical clustering model 560 can generate job hierarchies 171 with a different numbers of levels. For example, a job hierarchy 171 with two levels: all the “marketing managers” in the organization); and then the second level groups related jobs/roles (e.g. “marketing manager” together with “pay per click (PPC) manager” and “branding manager”—all related to the job family “marketing”).
g) Based on the generated job clusters 171 and the skills predicted for them by model 555, algorithm 565 for selecting skills that are both relevant and non-trivial for display and design. The input is the ranking of the skill predictions from model 555. This probabilistic ranking is then trimmed by removing skills that are not affine to the cluster (up to some threshold). To calculate whether a skill is affine to a cluster Y which is a sub-cluster of cluster X in the generated hierarchy, we shall consider (a) the likelihood P_{J} of the skill appearing in the cluster Y according to model 555 (b) the likelihood P_{F} of the skill appearing in the super-cluster X according to model 555 and (c) the likelihood P_{C} of the skill appearing in the organization (not necessarily in the cluster) according to model 555. For a threshold T (which can be determined arbitrarily, e.g. T=1.02), each skill will then be considered affine to cluster Y if one of the following conditions holds: P_{J}/P_{F}>T (i.e. the skill is much more related to the job compared to the rest of the job cluster) or P_{J}/P_{C}>T (i.e. the skill is much more related to the job compared to entire company).
h) Based on the company-specific skills for model 555, a typical skill model 570 captures the typical skills for each of the job-clusters produced in model 560.

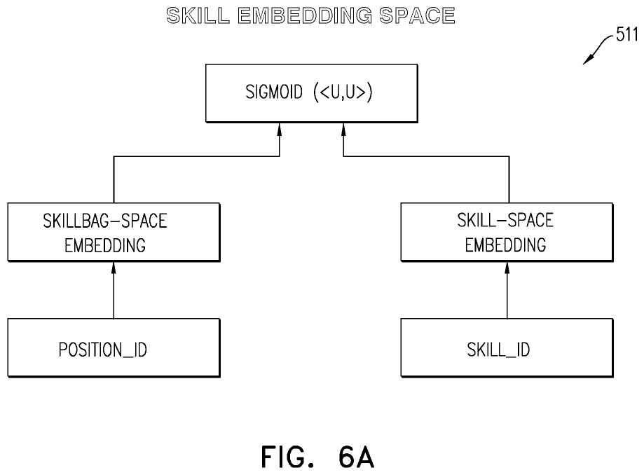

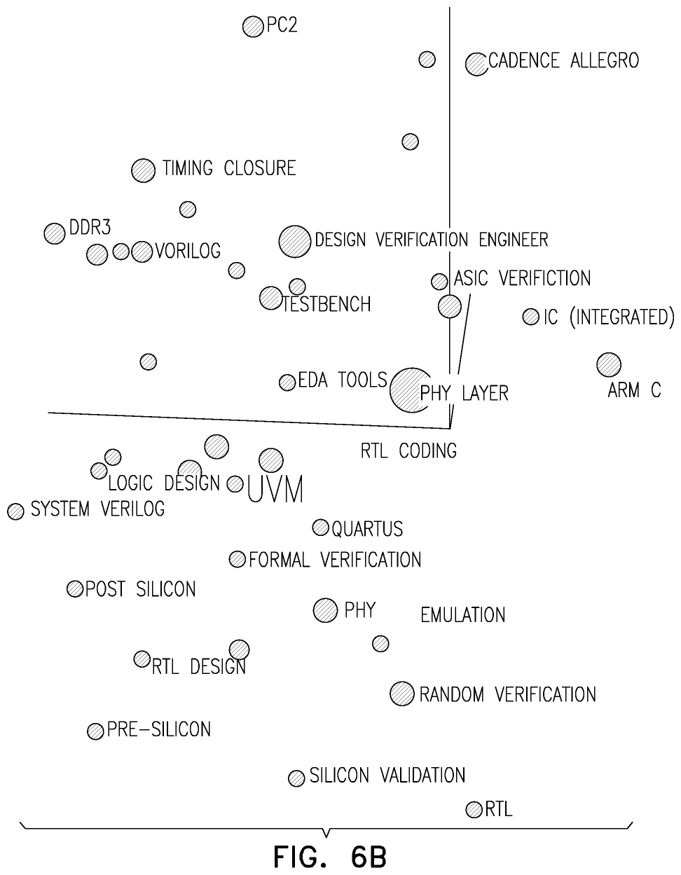

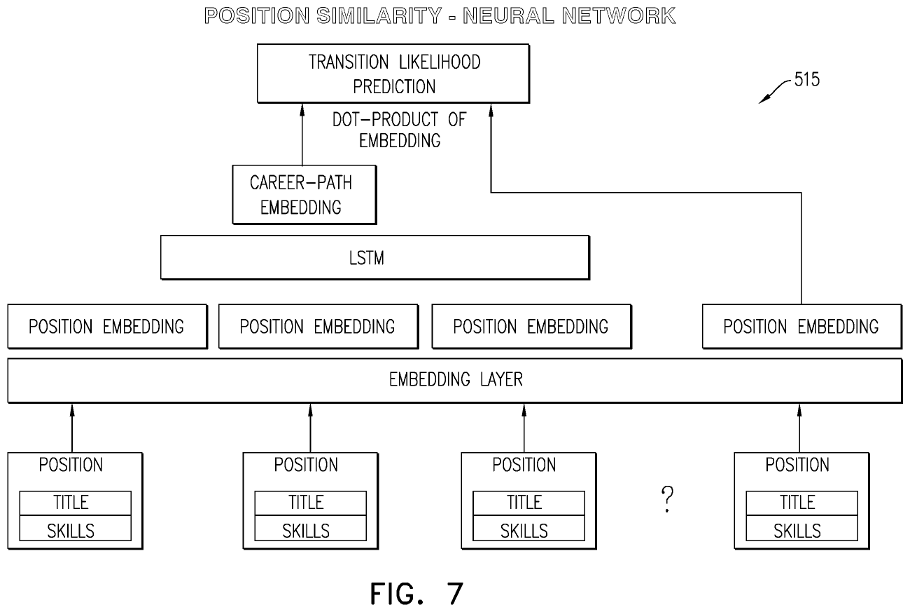

FIG. 6A is a schematic illustration of an architecture of the model 511 that generates a skill embedding space 512, and FIG. 6B is a schematic illustration of a skill embedding space 512, according to an embodiment of the disclosure.

In an embodiment of the disclosure, the skill embedding space model 512 is formed by simultaneously training two embedding layers: One of documents (in our case, jobs/roles/Positions) and another of terms (in our case, Skills). The model 512 is trained to find weights (the embedding) by training it to predict, for a given pair <<job_id, skill_id>>, whether the skill was linked to the job in the training set. The outcome is a job-embedding and a Skill-embedding, that can be used together to predict the likelihood of a skill in a job. Optionally, the above model 512 arrives at a representation for each bag of skills (referred to as the skill embedding space 512), where the representation for each bag predicts the probability of other skills also belonging to the same bag despite not being specified in it.

Thus we have described how to generate an embedding from a bag of skills. Following generation of the embedding job titles are incorporated into the same embedding space.

In an embodiment of the disclosure, model 513 is trained so that for a given job title, the model 513 approximates the job's location in the skill-bag space. In other words, this assigns each job title the probability of each skill belonging to that job.

For each job, we would then like to combine the title-embedding (from 513) with the skill-bag-embedding (from 512), to arrive at a job-embedding space 520. This is in the same mathematical space as the skill-bag-embedding, and therefore can be used to predict probabilities of having additional skills.

A naive implementation for the combination 515 would be to average the title-based representation 513 with the skill-based representation 512. However, this is far from an optimal solution:
1. Intuitively, consider the title “Engineer” and the skills “planning” on the one hand and “software development” on the other hand. The skill “planning” does not drastically affect the profile of an Engineer, but the skill “software development” easily allows one to re-classify the engineer into a large, broad sub-category of engineers.
2. On the other hand, consider the effect the skill “UX design” would have upon a server-side software developer (mostly irrelevant, so ideally should not have much effect) vs. upon a product manager (highly relevant, and again allows the reader to determine a sub-category of product managers).

Therefore, a smarter model 515 is called for to combine title-based representation with skill-based representation. For that, we use the Cascade Model, as follows:
1. Intuitively, the cascade model's (515) goal is: “use the title-based representation, completing information from the skill-based representation if needed and ONLY if needed”. The key factor is defining the information to be completed. We divide the information along algebraic axes. Therefore, since the representations are vectors in multidimensional space, each job title will be dominant and roughly “fixed” in some of the axes (coordinates), and more flexible in the other axes (coordinates)—in which it will seek to complete information based on skills. The combination, therefore, will be a linear combination of the vectors along each axis separately.
2. Because the model 515 relies on separate treatment of axes, the first step is to make each axis independent by transforming the representation into an orthogonal space, using (principle component analysis) PCA. So instead of working in the title space, we are now working in the PCA-transformed title space.
3. Train a model C1, transforming from the skill embedding space (which is also the title embedding space), to the same dimension; however, the output of this model is not a vector that is part of this embedding, but a vector of weights in this space. Given a representation vi (in this case, one vector that is based on the title), this model predicts the variability of each axis in the corresponding skill vectors, of jobs with title 1. This model predicts which of the components (coordinates) will have low variance (“common to most people with this title)” vs the components (coordinates) that have high variance (“different between different people that have this title”). Intuitively, Vengineer would have low weights around the components related to “engineering” skills and “human resources” skills (since the vast majority of engineers do have engineering skills and don't have human resources skills—this doesn't vary); but it would have high weights around more specific skills related to engineering (e.g. software development, mechanical engineering etc.), because these are the skills that differentiate between engineers. The model would estimate the variance for each coordinate; the output vector is of weights predicting the variance along each axis, given the title.
4. Following this, given a title-based vector vₜ (from 513) and a skill-based vector vs (from 512) for a job, we can combine them as follows:

$${w}_{t} = C 1 ( {v}_{t} )$$

(where “C1” is the cascade model, i.e. generating vector of weights based on the title vector)

$${v}_{pos} = {w}_{t} \cdot {v}_{t} + ( 1 - {w}_{t} ) \cdot {v}_{s}$$

This leads to:
a. An embedding space for skills 512.
b. A model 515 that-given a job title and a collection of skills, generates a vector in that space, from which it is directly possible to infer the probability of having any other skill.
c. A model 520 that directly uses the predictions from model 515 to measure similarities of jobs.
5. The next steps will partially repeat the previous steps, with company-specific information.
6. Use the data about the employees of one company, or one industry, to form a fine-tuning (model 555) of model 510 (skill+title implications upon other skills). By “fine-tuning” it is meant that a training process is started based on the weights calculated in model 510, but the further iterations to update these weights are only done based on data samples from the company, and not data samples from the entire data set. This is an instance of transfer learning, where the model leverages the wisdom gathered from the global data.
7. From model 555, extract the final embedding layer, which represents a single job as a vector. This becomes the company-specific job similarity model 559.
8. Use a known hierarchical clustering algorithm, based on the metrics/distances between job distances as reflected by the job embedding model 559, to generate hierarchical clusters 560. The number of clusters and other parameters may vary; good values are around 3 levels of hierarchy with K=200 clusters. Each of these clusters is a Job Profile, and they are sorted in a hierarchy.
9. Using the model 555, and again the document-embedding method from 555, find a representation for each of the clusters 560. That is, train a document-embedding in such a way that the vector for each of the job clusters will predict the probability of finding any skill in a single person belonging to that cluster. (That is, it is the same algorithm, but now instead of each job being a skill-bag, each Cluster is a skill-bag).
10. Finally, calculate typical skills for each job profile, as follows:
   a. Model 565: For each job profile, use its representation from 559 and the model from 555 to find the list of most affine skills. This means, the skills that are likeliest to appear in this job profile compared to their likelihood of appearing in the cluster's parent. In the case of top-level clusters, the comparison is to the skills' likelihood of appearing in the employee population at large.
   More formally:

$$score = [ P ( skill \vert job ) - P ( skill ) ] / [ 1 - P ( skill ) ]$$

Wherein P(skill|job) is the result of model 559; P(skill) is calculable in a straightforward manner from the data—the occurrence ratio of this skill across the data set.
b. Optionally, use a dictionary of skill relations to remove duplicates or unify similar skills (e.g. don't output both “project management” and “project management skills”). This is not critical for the end result, but would improve readability.
The list of skills is the list of typical skills for each job profile.
11. Moving to the third step: reassigning employees to job profiles.
   a. The assumption for this application is that each employee is already assigned to a certain job profile, and that in some instances this assignment is wrong.
   b. model 570 described above is a model that generates a description of the skills of each job profile.
   c. Now, calculate the multi-variance of each job profile (i.e. the squared expected difference in each axis between: [the skill-embedding of each employee within a job profile] and [the skill-embedding of the entire job profile as generated in model 570]).
   d. The result of model 570 and the previous step are the average and variance of the embedding of each job. From the variance, the standard deviation is trivially derived by the square root. Now each employee can be measured compared to each job: What's the distance from that employee's embedding to the job's embedding, normalized by the standard deviation of each axis. Each employee can then be said to “belong” to the job profile to which they're closest according to that measure. The reason for calculating the distance according to standard deviations is that some jobs are more dispersed than others (i.e. their skills vary more), and in such cases we need to allow employees to belong in those dispersed job codes despite not matching them exactly. Therefore, the distance of each employee to each of the clusters should be measured in standard-deviations of that cluster's membership (e.g. “employee 123 is 2.3 standard deviations away from job X”).
   e. It is now simple to compare the resulting job profile assignment of each employee, to their job to which they're actually assigned; and to highlight the differences (e.g. “employee #123 is currently described as an IT Engineer but should be described as a Software Developer”). From these results, employees that only have 0-2 skills should be excluded, because their automatic assignment lacks statistical confidence.

The above process provides a job hierarchy 171 (from model 560); typical skills for each of these jobs 570; and the association between each employee and his or her job by module 580 to provide a job architecture 170.

Optionally, the last step is presenting these results to a human specialist in a graphical interface, in order to allow them to review and make final changes to these automatically-generated results.

In an embodiment of the disclosure, application 150 may be stored on a non-transitory computer readable medium, for example a disk, CD-ROM, DVD, disk-on-key or other devices. Optionally, the medium may be transferred to a computer and executed to perform application 150.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

I/We claim:

1. A method of forming a job architecture of an organization, comprising:
collecting information from employees of the organization by an application executed on a computer;
analyzing the information with a neural network to form a job hierarchy for the organization;
associating each employee of the organization with a job from the job hierarchy to form a job architecture for the organization;
displaying the job architecture on a display.

2. The method of claim 1, wherein the application is configured to identify missing or redundant employees from the job architecture.

3. The method of claim 1, wherein the application is configured to enable an employer to add information regarding jobs that are not currently filled by employees.

4. The method of claim 1, wherein the application suggests training for employees to improve their qualification relative to colleagues.

5. The method of claim 1, wherein the neural network trains a job similarity model to identify similar jobs based on job titles.

6. The method of claim 1, wherein the neural network trains a skill embedding space model to identify skills related to job titles.

7. The method of claim 1, wherein the neural network trains a model to correlate between titles and skills.

8. The method of claim 1, wherein the neural network trains a job similarity model to cluster and group jobs.

9. The method of claim 1, wherein the neural network is trained based on a job description data set that describes skills required for specific job titles.

10. The method of claim 1, wherein the neural network is trained based on an employee job description data set that includes a series of career transitions of employees.

11. A computer for producing a job architecture of an organization, comprising a processor and memory programmed to execute an application performing:
collecting information from employees of the organization;
analyzing the information with a neural network to form a job hierarchy for the organization;
associating each employee of the organization with a job of the job hierarchy to form an job architecture for the organization;
displaying the job architecture on a display.

12. The computer of claim 11, wherein the application is configured to identify missing or redundant employees from the job architecture.

13. The computer of claim 11, wherein the application is configured to enable an employer to add information regarding jobs that are not currently filled by employees.

14. The computer of claim 11, wherein the application suggests training for employees to improve their qualification relative to colleagues.

15. The computer of claim 11, wherein the neural network is configured to train a job similarity model to identify similar jobs based on job titles.

16. The computer of claim 11, wherein the neural network is configured to train a skill embedding space model to identify skills related to job titles.

17. The computer of claim 11, wherein the neural network is configured to train a model to correlate between titles and skills.

18. The computer of claim 11, wherein the neural network is configured to train a job similarity model to cluster and group jobs.

19. The computer of claim 11, wherein the neural network is trained based on a job description data set that describes skills required for specific job titles.

20. The computer of claim 11, wherein the neural network is trained based on an employee job description data set that includes a series of career transitions of employees.

21. A non-transitory computer readable medium comprising a set of instructions that are executable by a computer to perform the method of claim 1.
